(19) United States
(12) Patent Application Publication
(10) Pub. No.: US 2011/0126010 A1
(43) Pub. Date: May 26, 2011

(54) SERVER, SYSTEM AND METHOD FOR MANAGING IDENTITY

(75) Inventors: Soo Hyung KIM, Daejeon (KR); Young Seob CHO, Daejeon (KR); Jin Man CHO, Daejeon (KR); Sang Rae CHO, Daejeon (KR); Dae Seon CHOI, Daejeon (KR); Jong Hyouk NOH, Daejeon (KR); Seung Hyun KIM, Daejeon (KR); Kwan Soo JUNG, Daejeon (KR); Deok Jin KIM, Daejeon (KR); Seung Hun JIN, Daejeon (KR)

(73) Assignee: Electronics and Telecommunications Research Institute, Daejeon (KR)

(21) Appl. No.: 12/795,254

(22) Filed: Jun. 7, 2010

(30) Foreign Application Priority Data
Nov. 23, 2009 (KR) 10-2009-00113521

(51) Int. Cl. G06F 21/00; H04B 5/00; G06F 15/16; H04L 9/32

(52) U.S. Cl. 713/168; 455/41.1; 709/203; 726/3

(57) ABSTRACT

Disclosed herein is a system and method for managing identity. The system includes a mobile terminal, a web server, and a service terminal. The mobile terminal includes a smart card on which a management server for managing user identity is mounted. The web server generates the user identity and provides the generated identity to the management server over a wired/wireless network. The service terminal receives a required identity from the mobile terminal using Near Field Communication (NFC).

### CROSS-REFERENCE TO RELATED APPLICATIONS

This application claims priority under 35 U.S.C. §119 to Korean Patent Application No. 10-2009-0113521, filed on Nov. 23, 2009, in the Korean Intellectual Property Office, the disclosure of which is incorporated herein by reference in its entirety.

### BACKGROUND OF THE INVENTION

1. Field of the Invention

The present invention relates generally to a server, system and method for managing identity, and, more particularly, to a method of managing and using a user's own identity using a smart card included in a mobile terminal.

2. Description of the Related Art

A smart card is a safe and efficient device for verifying personal identity, and is widely used in various fields, such as communications using a Universal Integrated Circuit Card (UICC), a travel service using an electronic passport, and financial transactions using a credit card. Technologies related to a smart card include technologies for providing a hardware operation module capable of rapidly performing security operations, technologies for storing multimedia data of several Gigabytes, and technologies for directly processing Hypertext Transport Protocol (HTTP) messages within the smart card.

User identity may be defined as user-related information such as personal website authentication information (e.g., an ID and a password), personal information, information about a service or an institution to which a user belongs, financial transaction information, or personal preference. Related technologies for managing such digital identities include Windows CardSpace and OpenID.

In the field of smart card technology, technologies to which digital identity is applied are partially used in limited range (e.g., a payment card, communication subscriber information and passport information) or limited service domains (e.g., a financial domain and a communication domain). For an example, the digital identity technology is at the level where a financial institution in cooperation with a telecommunication company stores information about the payment card of a mobile phone owner in the UICC (USIM) of the mobile phone using Over The Air (OTA) technology, and the user makes payments at member stores in cooperation with the telecommunication company. For another example, telecommuters who work for a specific organization use smart cards to prove their identities and use services to and at web servers provided in the corresponding organization.

If it is sought to use more various identities in various service domains than in the above examples, the following technical problems must be overcome.

First, service providers in various fields need to safely and conveniently store identities, managed by the service providers, in the smart cards of users. Second, various types of user identities in smart cards should be managed in an integrated manner, and users need to directly search for or control (e.g., delete or use) the managed identities. Third, when an identity must be provided in response to request from a specific service provider, a user should be able to check or select the provided identity and the provided identity should not be exposed or modified to or by a service provider other than the specific service provider.

### SUMMARY OF THE INVENTION

Accordingly, the present invention has been made keeping in mind the above problems occurring in the prior art, and an object of the present invention is to enable service providers in various fields to store various identities in smart cards over a network.

Another object of the present invention is to enable various identities to be conveniently managed and used in smart cards using a unique classification system.

Still another object of the present invention is to enable a user identity to be provided to a service terminal or a web server after the user's approval or selection.

In order to accomplish the above objects, the present invention provides a mobile terminal including a smart card on which a management server is mounted; a web server for generating the user identity and providing the generated identity to the management server over a wired/wireless network; and a service terminal for receiving a required identity from the mobile terminal using Near Field Communication (NFC).

Additionally, in order to accomplish the above objects, the present invention provides a website interfacing unit for receiving user identities from a web server over a wired/wireless network; an identity management unit for classifying the received identities on an attribute basis; a service terminal interfacing unit for receiving an identity request signal from a service terminal; and a response generation unit for analyzing the identity request signal, and generating a response message in response to the identity request signal.

Additionally, in order to accomplish the above objects, the present invention provides a method in which a mobile terminal of a user, including a smart card, manages user identity using a server of a service provider which operates a website, the method including requesting the setting of authentication information from the server of the service provider and receiving information about the website from the server of the service provider; setting a secret key along with the server of the service provider; requesting the server of the service provider to issue a service domain certificate; receiving the service domain certificate, comprising the user identity issued using the secret key, from the server of the service provider; and storing the information of the website and the service domain certificate in the smart card.

Additionally, in order to accomplish the above objects, the present invention provides a method in which a service terminal receives a user identity from a mobile terminal of the user on which a management server for managing the user identity is mounted, the method including sending an identity request signal, including an identity identification code, to the mobile terminal through NFC; and receiving an identity, processed by the mobile terminal based on the identity identification code, from the mobile terminal.

### BRIEF DESCRIPTION OF THE DRAWINGS

The above and other objects, features and advantages of the present invention will be more clearly understood from the following detailed description taken in conjunction with the accompanying drawings, in which:

FIG. 1 is a schematic block diagram of an identity management system according to the present invention;

FIG. 2 is a schematic block diagram of the management server shown in FIG. 1;

FIG. 3 is a schematic block diagram of the website module shown in FIG. 1;

FIG. 4 is a schematic block diagram of the service terminal module shown in FIG. 1;

FIG. 5 is a schematic block diagram of the gateway shown in FIG. 1;

FIG. 6 is a schematic block diagram of the proxy server shown in FIG. 1;

FIG. 7 shows an embodiment of a method of managing an identity according to the present invention, and is a diagram showing a procedure in which a web server registers a user identity with the management server;

FIG. 8 shows an embodiment of the method of managing an identity according to the present invention, and is a diagram showing a procedure in which the web server and the management server perform mutual authentication;

FIG. 9 shows an embodiment of the method of managing an identity according to the present invention, and is a diagram showing a procedure in which the management server provides a user identity to the web server;

FIG. 10 shows an embodiment of the method of managing an identity according to the present invention, and is a diagram showing a procedure of providing a user identity from the management server to a service terminal;

FIG. 11 shows an embodiment of the method of managing an identity according to the present invention, and is a diagram showing a procedure in which the web server is further included in the procedure of FIG. 10;

FIG. 12 illustrates the concept of a service domain certificate used in the present invention; and

FIG. 13 illustrates the concept of an envelope used in the present invention.

### DESCRIPTION OF THE PREFERRED EMBODIMENTS

The advantages and characteristics of the invention and methods for accomplishing them will become more apparent from the following embodiments which will be described in detail in conjunction with the accompanying drawings. However, the present invention is not limited to the following embodiments, but may be implemented in a variety of manners. These embodiments are provided to complete the disclosure of the present invention and to help those having ordinary skill in the art to understand the scope of the present invention. The present invention is defined only by the claims. Meanwhile, the terms used in the specification are provided to describe the embodiments, but are not intended to limit the present invention. In the specification, a singular form, unless specially mentioned otherwise, can include a plural form. The terms ‘include(s) or comprise(s)’ and ‘including or comprising’ used in the specification are not intended to exclude the existence or addition of one or more other components, steps, operations, and/or elements from a mentioned component, step, operation, and/or element.

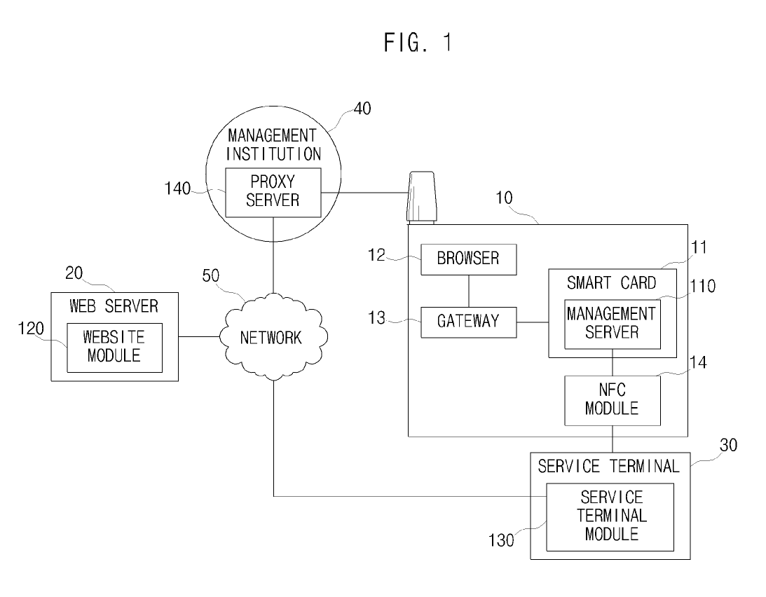

FIG. 1 is a schematic block diagram of an identity management system (hereinafter referred to as the ‘system’) using a smart card according to the present invention. The system according to the present invention, as shown in FIG. 1, includes a mobile terminal 10, a web server 20, a service terminal 30, and a management institution 40.

The mobile terminal 10 includes a smart card 11, a browser 12, a gateway 13, and a Near Field Communication (NFC) module 14. A Personal Identity Management Server (PIMS) 110 for managing a user identity is mounted on the smart card 11. The browser 12 is means for allowing a user to access the management server 110 or a website operating in conjunction with the web server 20. The gateway 13 is means for enabling the browser 12 to access the management server 110. Although in FIG. 1, the browser 12 is illustrated as the means for enabling a user to access the management server 110 or a website, the present invention is not limited thereto because some other type of terminal may be used.

The web server 20 includes a website module 120 which generates a user identity and transfers the generated identity to the management server 110 over a wired/wireless network. The website module 120 may receive a user identity from the management server 110 and check the received identity. The web server 20 may be operated by a service provider which provides a user with a service, such as a financial service or a medical service. The service provider operates a website in conjunction with the web server 20.

The service terminal 30 includes a service terminal module 130 which requests required identity from the management server 110 using NFC, such as Near Field Communication (NFC), and receives the requested identity from the management server 110. The service terminal 30 may be operated by a member store which provides products or services. The identity required by the service terminal 30 may vary depending on products or services provided by the member store. For example, if the member store provides a home-delivery service, the required identity may be a user's home address or telephone number.

The management institution 40 provides remote service to a user such that, for example, when the user loses his mobile terminal 10, the user can use his identity through a second mobile terminal, not the mobile terminal 10. In order to provide such remote service, the management institution 40 includes a proxy server 140.

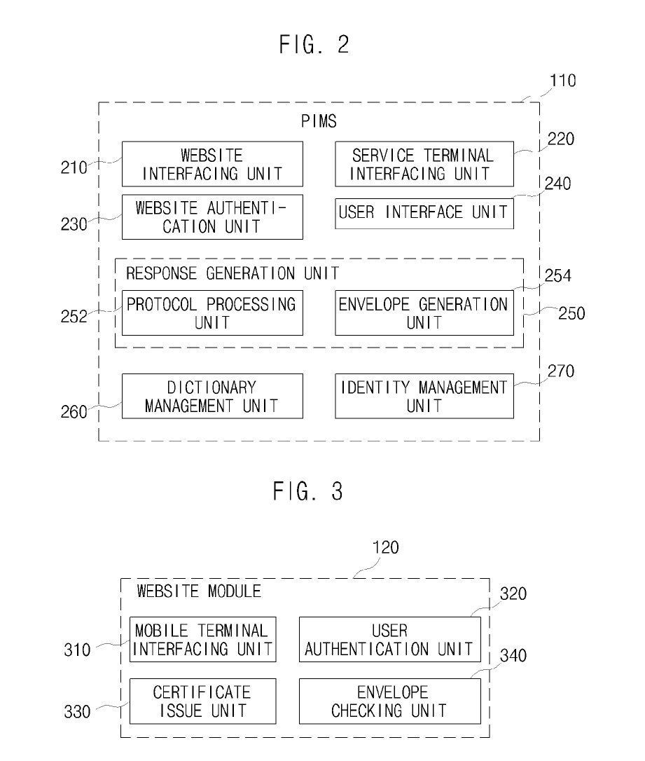

Each of the elements of FIG. 1 will be described in more detail below with reference to FIGS. 2 to 6.

FIG. 2 is a schematic block diagram of the management server 110 included in the mobile terminal 10. The management server 110 includes a website interfacing unit 210, a service terminal interfacing unit 220, a website authentication unit 230, a user interface unit 240, a response generation unit 250, a dictionary management unit 260, and an identity management unit 270.

The website interfacing unit 210 enables a user to exchange protocol messages with the web server 20 via the browser 12 of the mobile terminal 10. The protocol messages exchanged between the web server 20 and the mobile terminal 10 may be a request for identity and a transmission in response to the request. For example, the mobile terminal 10 may request the user identity, generated by the web server 20, from the web server 20. In response to the request from the mobile terminal 10, the web server 20 may generate the identity for the user and send it to the mobile terminal 10. Alternatively, the web server 20 may request the user identity from the mobile terminal 10. In this case, the user identity requested by the web server 20 may be an identity which is directly input by the user.

The service terminal interfacing unit 220 enables the mobile terminal 10 to exchange protocol messages with the service terminal 30. The exchange of the protocol messages between the mobile terminal 10 and the service terminal 30 may be performed through the NFC module 14. The protocol message exchanged between the mobile terminal 10 and the service terminal 30 may be a request for an identity and a transmission in response to the request. For example, the service terminal 30 may request a required identity from the mobile terminal 10, and the mobile terminal 10 may send the requested identity to the service terminal 30.

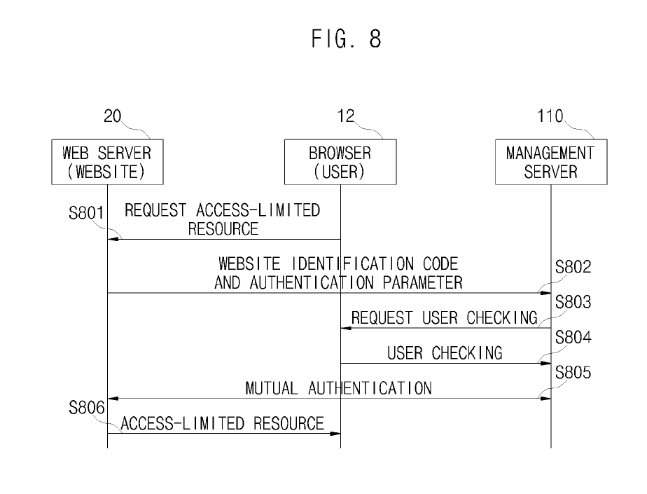

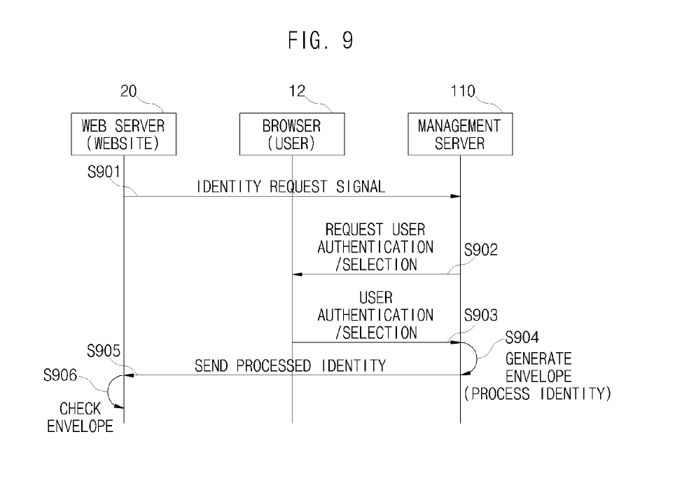

The website authentication unit 230 includes a routine for performing key setting along with the web server 20 and a routine for performing mutual authentication after key setting. The website authentication unit 230 performs mutual authentication with the web server 20. Mutual authentication will be described with reference to FIG. 8.

When a user desires to generate or check an identity, the user interface unit 240 provides the user with interfacing relevant to the generation, checking or both of the identity. An identity may not only be provided by the web server 20, but an identity may be also separately received from a user through the user interface unit 240.

The response generation unit 250 analyzes a protocol message (i.e., an identity request signal) received from the service terminal 30, generates a response message in response to the identity request signal, and sends the generated response message to the service terminal interfacing unit 220. The response generation unit 250 includes a protocol processing unit 252 and an envelope generation unit 254. The protocol processing unit 252 analyzes a protocol message received from the service terminal 30. The envelope generation unit 254 generates an envelope, which is a format for transmitting an identity. The envelope includes the identity requested by the service terminal 30. The envelope will be described later with reference to FIG. 13.

The dictionary management unit 260 defines an identification code and a meaning for a user identity on an attribute basis, and manages a service domain dictionary. The identity management unit 270 has a function of storing, searching for, and deleting a user identity generated by the web server 20 or a user. The dictionary management unit 260 and the identity management unit 270 operate in conjunction with each other so that when an identity request signal is received from the service terminal 30 or the web server 20, the dictionary management unit 260 and the identity management unit 270 can easily search for the corresponding identity.

FIG. 3 is a schematic block diagram of the website module 120 included in the web server 20. The website module 120 includes a mobile terminal interfacing unit 310, a user authentication unit 320, a certificate issue unit 330, and an envelope checking unit 340.

The mobile terminal interfacing unit 310 exchanges protocol messages with the management server 110 through the browser 12 of the mobile terminal 10. The protocol messages exchanged between the web server 20, including the mobile terminal interfacing unit 310, and the mobile terminal 10 are as described above in conjunction with the website interfacing unit 210.

The user authentication unit 320 includes the routine for performing key setting along with the management server 110 and the routine for performing mutual authentication after key setting. The user authentication unit 320 performs mutual authentication along with the website authentication unit 230 of the mobile terminal 10.

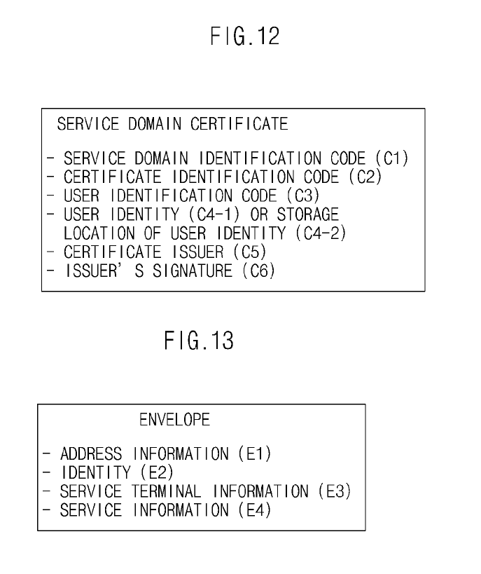

The certificate issue unit 330 issues a service domain certificate, including the user identity generated by the web server 20 and website guarantee information about the identity. For example, the user identity which is provided by the web server 20 to the mobile terminal 10 may be sent in the form of a service domain certificate. The service domain certificate will be described in more detail later with reference to FIG. 12.

The envelope checking unit 340 checks an envelope, including a user identity received from the user or the service terminal 30, and acquires and/or confirms the user identity included in the envelope.

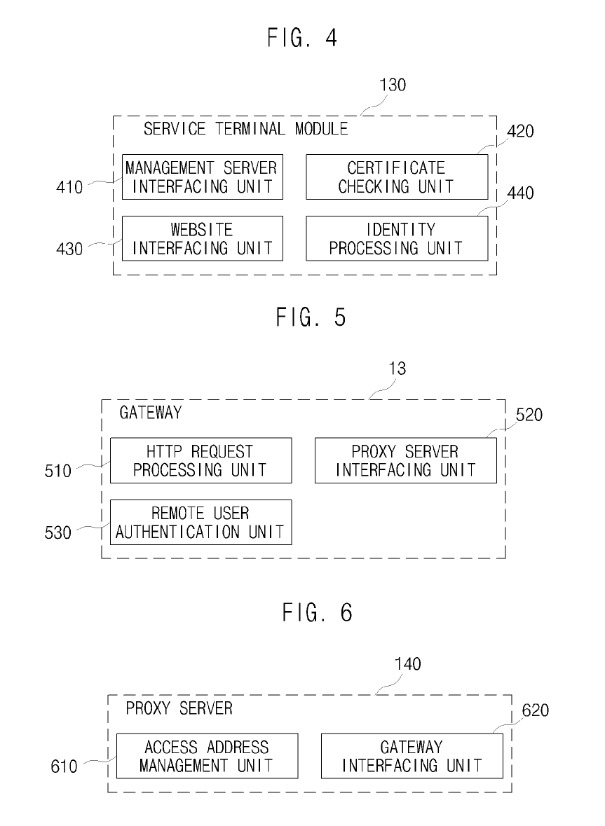

FIG. 4 is a schematic block diagram of the service terminal module 130 included in the service terminal 30. The service terminal module 130 includes a management server interfacing unit 410, a certificate checking unit 420, a website interfacing unit 430, and an identity processing unit 440.

The management server interfacing unit 410 exchanges protocol messages with the management server 110 of the mobile terminal 10 using NFC. The service terminal 30 requests a required identity through the management server interfacing unit 410. In response to the request for the identity, the management server 110 sends the corresponding identity to the service terminal 30. The identity sent to the service terminal 30 in response to the request may be in the form of a service domain certificate.

The certificate checking unit 420 checks the service domain certificate received from the management server 110, and acquires a user identity from the corresponding certificate.

In another embodiment of the present invention, the service terminal 30 may receive the service domain certificate, including the identity, via the web server 20, in addition to the case in which the service terminal 30 directly receives the service domain certificate from the management server 110. In this case, the management server 110 sends an envelope, including a requested identity, to the service terminal 30. The website interfacing unit 430 receives the envelope from the management server 110, and sends it to the web server 20. The web server 20 extracts the identity, requested by the service terminal 30, from the envelope, and provides the extracted identity to the service terminal 30.

The identity processing unit 440 manages the identification code of an identity required by the service terminal 30. When the service terminal 30 requests the required identity from the management server 110, an identification code corresponding to the identity is included in the identity request signal.

FIG. 5 is a schematic block diagram of the gateway 13 included in the mobile terminal 10. The gateway 130 includes an HTTP request processing unit 510, a proxy server interfacing unit 520, and a remote user authentication unit 530.

The HTTP request processing unit 510 opens a TCP port accessible to the browser 12 of the mobile terminal 10, and sends an HTTP message, sent by the browser 12, to the management server 110 through a smart card terminal interface. Furthermore, the HTTP request processing unit 510 returns a HTTP response message, sent by the management server 110, to the browser 12. For example, an address that the browser 12 of the mobile terminal 10 uses to access the HTTP request processing unit 510 may be, for example, http://127.0.0.1:1234/pims. The HTTP request processing unit 510 opens the TCP port 1234, and waits for the reception of a message.

The proxy server interfacing unit 520 exchanges messages with the proxy server 140. The remote user authentication unit 530 authenticates a user when the user attempts to access the remote user authentication unit 530 using a second terminal which is other than the mobile terminal 10 including the management server 110.

FIG. 6 is a schematic block diagram of the proxy server 140 included in the management institution 40. The proxy server 140 includes an access address management unit 610 and a gateway interfacing unit 620.

The access address management unit 610 manages a URL for access to the management server 110 when a user attempts to use an identity stored in the management server 110 through a second terminal. The URL for access to the management server 110 may be, for example, “http://www.proxy.com/01012341234.” Here, “http://www.proxy.com” corresponds to the address of a proxy server, and ‘01012341234’ is information that the proxy server 140 uses to identify the mobile terminal 10 including the management server 110. The access address management unit 610 searches for information about the user's mobile terminal corresponding to the information ‘01012341234’.

The gateway interfacing unit 620 sends an identity request signal to the gateway 13 of the mobile terminal 10 identified by the access address management unit 610. For example, the gateway interfacing unit 620 may send an HTTP message, received in the form of a URL, to the gateway 13 of the mobile terminal 10. Furthermore, the gateway interfacing unit 620 receives an HTTP response message (i.e., a response message) from the gateway 13 of the mobile terminal 10, and sends it to a second terminal.

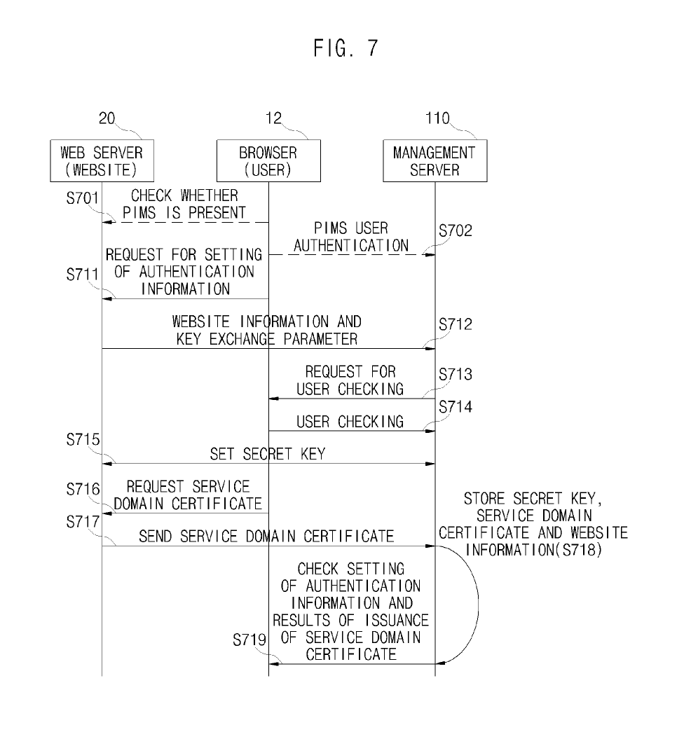

FIG. 7 shows an embodiment of a method of using the identity management system according to the present invention, and is a diagram showing a procedure in which the web server registers a user identity with a smart card. In the embodiment of the present invention, the web server 20 may be operated by a service provider which provides a specific service while operating a website, as described above. In this case, the web server 20 corresponds to the server of the service provider. This is the same for FIGS. 8 and 9.

A user accesses the web server 20 through the browser 12 of the mobile terminal 10. Here, the browser 12 may include and send information about the management server 110 in an HTTP request header at step S701. The content included in the header may be similar to browser information sent to a user agent. For example, the content may be represented as follows. The following PIMS service URL includes port information which can be received by a gateway.

PIMS/1.0; 127.0.0.1:1234/pims/protocol PIMS version; PIMS service URL

When the user inputs user authentication information (e.g., a Personal Identification Number (PIN) or biometric information) through the browser 12, the management server 110 becomes available to the user at step S702. Although the user authentication information may be input by the user through the browser 12, it may also be input through some other application software.

The user requests the web server 20 to set authentication information through the browser 12 at step S711. In response to the request, the web server 20 sends its website information and a parameter for the exchange of a key to the management server 110 at step S712. The website information and the parameter may be sent to the PIMS service URL, sent at step S701, using the HTTP POST method, or may be sent using a browser redirection technique. The website information may include a website identification code which can be used to uniquely identify the corresponding website within the management server 110.

The management server 110 requests the user to identify himself or herself through the browser 12 at step S713. For example, the management server 110 may generate an HTTP response message, including a request for user identification, using the HTTP request message received at step S712, and send the generated HTTP response message to the user. For example, the HTTP response message may be a message, such as “Do you want to set authentication information along with the website www.website.com?” The HTTP response message is used to check whether a task intended by the user is identical with a task which will be performed by the management server.

After checking the content of the HTTP response message received at step S713, the user sends a signal indicative of the completion of the check to the management server 110 through the browser 12 at step S714.

The mobile terminal 10, including the web server 20 and the management server 110, sets a secret key at step S715. A protocol used at the step S715 of setting the secret key may be implemented using one of a variety of encryption schemes including an encryption scheme including the website identification code of step S712 and a code used to uniquely identify the user or the management server 110.

The user requests the web server 20 to issue a service domain certificate through the browser 12 at step S716.

In response thereto, the web server 20 issues the service domain certificate, including a user identity and sends the issued certificate to the management server 110 at step S717. For example, the web server 20 may safely send the service domain certificate to the management server 110 using the secret key generated at step S715.

The management server 110 stores the website information received at step S712, the secret key generated at step S715, and the service domain certificate generated at 5716 and sends corresponding results to the browser 12 at step S718. In another embodiment of the present invention, each of the website information, the secret key generated at step S715 and the service domain certificate may be stored separately as soon as it is received from the website server 20.

The user checks the setting of the authentication information and the results of the issuance of the service domain certificate by using the browser 12 at step S719.

Although in FIG. 7, the request for setting authentication information and the request for issuing the service domain certificate are performed at respective steps S711 and S716, they may be performed in a single step.

FIG. 8 shows an embodiment of the method of managing an identity according to the present invention, and is a diagram showing a procedure in which the web server 20 and the management server 10 perform mutual authentication using a user identity stored in the management server 10.

When a user requests a resource to which access by a website is prohibited through the browser 12, the browser 12 sends the corresponding request signal to the web server 20 at step S801.

In response thereto, the web server 20 sends a website identification code and an authentication parameter to the management server 110 at step S802. Here, in preparation for the case in which the management server 110 and the corresponding website have not yet set authentication information, the web server 20 may send the website an identification code and the authentication parameter, including the login page of the corresponding website or the URL of an authentication information setting page, to the management server 110. Furthermore, in the case in which mutual authentication has been normally completed, a URL to be accessed may be included in the website identification code and the authentication parameter.

The management server 110 searches for previously stored website information based on the website identification code and requests the user to perform confirmation using the retrieved website information at step S803. For example, the confirmation request signal may be an HTTP response message, such as “Do you want to log in to the website www.website.com?”.

After checking the HTTP response message, the user may send a signal indicative of the completion of the confirmation to the management server 110 through the browser 12 at step S804.

At step S805, the web server 20 and the management server 110 perform mutual authentication using the website identification code generated at step S712 and the secret key set at S715. The website provides the requested resource to the user at step S806.

FIG. 9 shows an embodiment of the method of managing an identity according to the present invention, and is a diagram showing a procedure of transferring a user identity, stored in the management server 110, to the web server 20 in response to the request from the web server 20.

When providing a user with a specific service through a website, the web server 20 may require the user's specific identity. For example, when a user requests the delivery of a product, the web server 20 may require the user's home address and telephone number. In this case, the web server 20 sends an identity request signal, including the identification code of the identity required for the provision of the service, to the management server 110 at step S901. The identity identification code may be an identification code for identifying a service domain certificate.

The management server 110 searches for an identity corresponding to the identity identification code, generates an HTTP response message related to the retrieved identity, and sends the HTTP response message to the browser 12 at step S902. For example, the HTTP response message may be a message, such as “A website www.website.com requests your home address and telephone number. Do you want to provide them?” For example, a number of identities (e.g., a home telephone number, a company telephone number, and a mobile phone number) having the same identity attribute (e.g., a telephone number) may have been registered with the management server 110. In this case, the procedure of FIG. 9 may further include the step of a user selecting a specific identity (e.g., a company telephone number).

The user checks the HTTP response message and sends a signal indicative of the approval of sending the identity to the management server 110 through the browser 12 at step S903.

The management server 110 generates an envelope by processing an identity corresponding to the identity request signal at step S904, and sends the generated envelope to the web server 20 at step S905. For example, the envelope (i.e., the processed identity) may be included and sent in an identity response signal. Here, the identity response signal may be protected using the secret key which is shared by the management server 110 and the web server 20.

The web server 20 may check the identity included in the envelope at step S906.

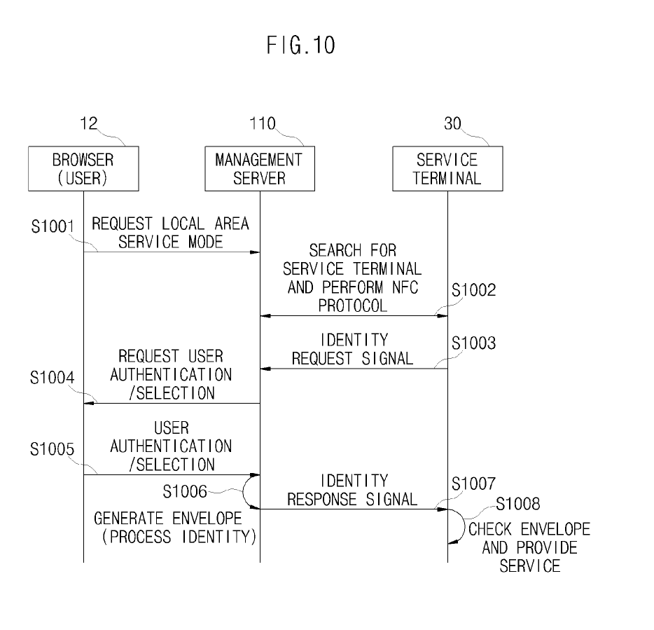

FIG. 10 shows an embodiment of the method of managing an identity according to the present invention, and is a diagram showing a procedure of transferring a user identity, stored in the management server 110, to the service terminal 30 in response to a request from the service terminal 30.

A user requests a local area service mode from the management server 110 through the browser 12 at step S1001. The local area service mode in the present invention is used to activate a smart card or the NFC module 14 mounted on the mobile terminal 10, thereby searching for an external service terminal 30 and enabling the exchange of messages between the service terminal 30 and the management server 110.

The smart card or the NFC module 14 of the mobile terminal 10 on which the smart card is mounted searches for the service terminal 30 and performs an NFC protocol at step S1002.

The service terminal 30 sends an identity request signal, including an identity identification code corresponding to an identity required for the provision of a service, to the mobile terminal 10 at step S1003. The identity request signal may be identical with the identity request signal described in conjunction with step S901 of FIG. 9, or may further include information about the service terminal 30 in the identity request signal described in conjunction with step S901.

The management server 110 of the mobile terminal 10 searches for an identity corresponding to the identity identification code, generates an HTTP response message related to the retrieved identity, and sends the HTTP response message to the browser 12 at step S1004. For example, the HTTP response message may be a message, such as “00 member store requests your home address. Do you want to provide it?”

The user checks the HTTP response message and sends a signal indicative of the approval of the sending of an identity after checking the HTTP response message to the mobile terminal 10 through the browser 12 at step S1005.

In response thereto, the management server 110 of the mobile terminal 10 generates an envelope by processing an identity corresponding to the identity request signal requested by the service terminal 30 at step S1006 and sends the generated envelope to the service terminal 30 at step S1007. For example, the envelope (i.e., the processed identity) may be included and send in an identity response signal. In another embodiment of the present invention, the identity processed into the envelope may have the form of a service domain certificate.

The service terminal 30 may check the received envelope and provide a service to the user using the identity included in the envelope at step S1008. When the identity included in the envelope is a service domain certificate, the procedure of FIG. 10 may further include the step of checking the service domain certificate.

In still another embodiment of the present invention, steps S1004 and S1005 may be omitted in response to a request from a user. For example, if, at step S1001, the user previously defines a specific identity so that the identity is provided and requests local area service mode, the management server 110 of the mobile terminal 10 may provide the user with the specific identity previously defined by the user without a procedure of checking the user in response to the identity request signal.

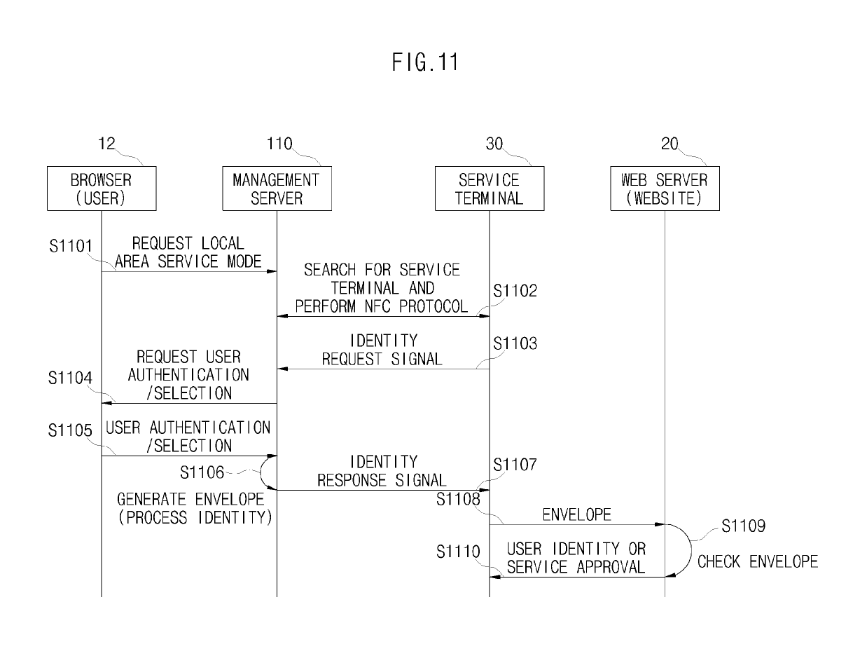

FIG. 11 shows an embodiment of the method of managing an identity according to the present invention, and is a diagram showing a procedure in which the web server 20 is further included in the procedure of FIG. 10 and the identity is sent to the service terminal 30.

When a user requests local area service mode from the management server 110 through the browser 12 at step S1101, a smart card or the NFC module 14 of the mobile terminal 10 on which a smart card is mounted searches for a service terminal and performs an NFC protocol at step S1102.

The service terminal 30 includes an identity identification code, including an identity required for the provision of a service, in an identity request signal and sends the identity request signal to the mobile terminal 10 at step S1103. The identity request signal may further include information about the service terminal. The identity request signal may further include information (e.g., a service name-payment, amount of money-1,000 Korean won) about the service provided by the service terminal 30 to the corresponding user.

The management server 110 of the mobile terminal 10 searches for an identity corresponding to the identity identification code, generates an HTTP response message related to the retrieved identity, and sends the HTTP response message to the browser 12 at step S1104. For example, the HTTP response message may be a message, such as “A website cafe #1 member store requests card information. Do you want to provide it? (Service name)-payment, (amount of money)-1,000 Korean won”.

The user checks the HTTP response message and then sends a signal indicative of the approval of the sending of the identity to the mobile terminal 10 through the browser 12 at step S1105.

The management server 110 of the mobile terminal 10 generates an envelope by processing the identity requested by the service terminal 30 at step S1106. The envelope may include an identity, information about a service terminal, and information about a service. For example, the management server 110 may declare that the identity requested by the service terminal 30 needs to be checked by the web server 20, so that the recipient of the envelope is set to the web server 20. The information about the service terminal 30 may include a signature value which is generated through a secret key which is shared by the web server 20 and the management server 110.

The management server 110 sends the envelope, obtained by processing the identity, to the service terminal 30 at step S1107.

The service terminal 30 having received the envelope checks the recipient included in the envelope, and sends the envelope to the web server 20 (i.e., the corresponding recipient) at step S1108.

The web server 20 receives the envelope from the service terminal 30 and checks the information of the service terminal 30 included in the envelope, or the information of the service and the identity requested by the service terminal 30, using the secret key at step S1109.

The web server 20 sends the checked identity to the service terminal 30 at step S1110. Here, the sent identity may not be the user's actual identity, but may be information for approving the service. For example, a method of sending information about the payment card of a user, information about the service terminal of a member store, and information about transactions through the envelope, checking a website, and sending an approval number to the service terminal 30 may be used.

FIG. 12 illustrates the concept of a service domain certificate used in the present invention. The service domain certificate may include a user identity generated by the web server 20 and provided to the mobile terminal 10. The service domain certificate, as shown in FIG. 12, may include a service domain identification code C1, a certificate identification code C2, a user identification code C3, a user identity C4-1 or the storage location of the user identity C4-2, a certificate issuer C5, and an issuer's signature C6.

The service domain identification code C1 is a code used to identify a service domain. In the present invention, a service domain refers to a virtual domain including service providers, each having a service or an apparatus for identifying and using an identity included in a certificate. For example, the service providers may be e-commerce websites, offline credit card member stores, hospitals, and drugstores.

The certificate identification code C2 is a code used to identify a certificate type within the service domain. The user identification code C3 is a code used to identify the user in the same service domain and the same certificate type. The user identity C4-1 is an identity provided by an issuer (i.e., a web server) which has issued a service domain certificate. The place C4-2 where the user identity is stored is a place where the user identity is stored and is used to search for an identity. The certificate issuer C5 includes information about a web server which has issued the service domain certificate. The issuer's signature C6 corresponds to signature information of an issuer for the service domain certificate.

In an embodiment of the present invention, the credit card information is meaningfully used to make a payment for a service or a product in e-commerce or at an offline credit card member store. Accordingly, credit card information (i.e., user identity information) may be included in the certificate. In this case, a service domain may be an e-commerce site or an offline credit card member store.

In still another embodiment, if medical information about a user is included in the service domain certificate as a user identity, a hospital, a drugstore and an Internet health site in which the corresponding medical information will be used may become a service domain.

The meaning of each identity and a code used to identify the identity within the service domain may be implemented using a document, memory or a file having a specific format, called a service domain dictionary.

FIG. 13 illustrates the concept of an envelope used in the present invention. As shown in FIG. 13, the envelope includes address information E1, an identity E2, service terminal information E3, and service information E4.

The address information E1 is information about an address to which an envelope must be transferred. The address may be a service terminal or a web server, as described above.

The identity E2 may be a service domain certificate registered with the management server, or may be a user's personal information, not a certificate. The user's personal information may include an address and a telephone number.

As described above in conjunction with FIG. 11, the service terminal information E3 may be included in the envelope in the case in which the envelope is sent to the web server 20 via the service terminal 30. The information about the service terminal 30 may not be modified through the secret key which is shared by the web server 20 and the management server 110 of the mobile terminal 10.

As described above in conjunction with FIG. 11, the service information E4 may be included in the envelope in the case in which the envelope is sent to the web server 20 via the service terminal 30. The information about a service E4 may be included in the envelope when the web server 20 which checks the envelope requires it. For example, assuming that an identity is a user's credit card information and the information about a service is service purchase information, the web server 20 can determine whether to approve a payment based on the information about a service.

The information about a service may be prevented from being modified by using the secret key which is shared by the web server 20 and the service terminal 30.

As described above, according to the present invention, there is an advantage in that user identities (e.g., credit card information) managed by service providers in various fields can be safely and conveniently stored in a user's smart cards using standard web technologies.

Furthermore, the present invention has an advantage in that a user can easily manage identities, configured to have various attributes and registered with his smart card, in an integrated fashion through the browser of a mobile terminal.

Furthermore, the present invention has an advantage in that an identity can be provided not only through a web server connected to the web but can also be provided over a short-range wireless network.

Furthermore, the present invention has advantages in that a user identity can be provided to a service terminal after a corresponding user directly confirms the user identity and in that privacy can be protected because an identity is not exposed to a third party.

Moreover, a user's mobile terminal and the web server can safely and conveniently perform mutual authentication using preset authentication information.

Although the preferred embodiments of the present invention have been disclosed for illustrative purposes, those skilled in the art will appreciate that various modifications, additions and substitutions are possible, without departing from the scope and spirit of the invention as disclosed in the accompanying claims.

What is claimed is:

1. A system for managing identity, comprising:
a mobile terminal having a smart card on which a management server for managing user identity is mounted;
a web server for generating the user identity and providing the generated identity to the management server over a wired/wireless network; and
a service terminal for receiving a required identity from the mobile terminal using Near Field Communication (NFC).

2. The system as set forth in claim 1, wherein the web server comprises:
a mobile terminal interfacing unit for communicating with the mobile terminal over the wired/wireless network; and
a certificate issue unit for issuing a service domain certificate, including the user identity and web server guarantee information for the identity.

3. The system as set forth in claim 1, further comprising a proxy server for providing a remote service for enabling the user to use the user identity, included in the management server, through a second terminal which is not the mobile terminal.

4. The system as set forth in claim 3, wherein the proxy server comprises:
an access management unit for analyzing an access request signal received from the second terminal, and identifying a mobile terminal which the second terminal attempts to access; and
a gateway interfacing unit for sending an identity request signal, included in the access request signal, to a gateway of the identified mobile terminal, receiving a response message from the gateway, and sending the response message to the second terminal.

5. A server for managing identity, comprising:
a website interfacing unit for receiving user identities from a web server over a wired/wireless network;
an identity management unit for classifying the received identities on an attribute basis;
a service terminal interfacing unit for receiving an identity request signal from a service terminal; and
a response generation unit for analyzing the identity request signal, and generating a response message in response to the identity request signal.

6. The server as set forth in claim 5, further comprising a website authentication unit which comprises at least one of a routine for performing key setting along with the web server and a routine for performing mutual authentication along with the web server.

7. The server as set forth in claim 5, further comprising a user interface unit for receiving an identity from the user, wherein the identity management unit manages the identities provided by the web server and the identity input by the user together.

8. A method in which a mobile terminal of a user, including a smart card, manages user identity using a server of a service provider which operates a website, the method comprising:
requesting setting of authentication information from the server of the service provider and receiving information about the website from the server of the service provider;
setting a secret key along with the server of the service provider;
requesting the server of the service provider to issue a service domain certificate;
receiving the service domain certificate, including the user identity issued using the secret key, from the server of the service provider; and
storing the information of the website and the service domain certificate in the smart card.

9. The method as set forth in claim 8, wherein the setting a secret key along with the server of the service provider is performed using an encryption scheme, including an identification code of the website used to identify the website and an identification code of a management server mounted on the smart card.

10. The method as set forth in claim 8, further comprising:
receiving an identification code of the website and an authentication parameter from the server of the service provider; and
performing mutual authentication along with the server of the service provider using the identification code of the website and the secret key based on the authentication parameter.

11. The method as set forth in claim 8, further comprising:
receiving an identity request signal from the server of the service provider; and
sending the requested identity to the server of the service provider.

12. The method as set forth in claim 11, wherein the sending the requested identity to the server of the service provider comprises:
receiving the identity request signal, including an identity identification code, from the server of the service provider;
searching the identities stored in the smart cards and processing an identity corresponding to the identity identification code; and
sending the processed identity to the server of the service provider.

13. The method as set forth in claim 12, wherein the sending the processed identity to the server of the service provider comprises encrypting and sending the processed identity using the secret key.

14. The method as set forth in claim 12, further comprising the step of, when the identity corresponding to the identity identification code includes a plurality of identifies from among the identities stored in the smart card, receiving a selection signal related to one of the plurality of identifies to be sent to the server of the service provider.

15. The method as set forth in claim 8, further comprising receiving a user identity input by the user and storing the input identity in the smart card.

16. A method in which a service terminal receives a user identity from a mobile terminal of the user on which a management server for managing the user identity is mounted, the method comprising:
sending an identity request signal, including an identity identification code, to the mobile terminal through NFC; and
receiving an identity, processed by the mobile terminal based on the identity identification code, from the mobile terminal.

17. The method as set forth in claim 16, wherein the identity request signal further includes service information provided by the service terminal to the user.

18. The method as set forth in claim 16, further comprising confirming an identity corresponding to the identity identification code based on the processed identity and providing the user with a service using the confirmed identity.

19. The method as set forth in claim 16, further comprising:
sending the processed identity to a web server associated with the service terminal; and
receiving an identity, corresponding to the identity identification code, from the web server, the identity corresponding to the identity identification code having been confirmed by the web server based on the processed identity.

20. The method as set forth in claim 16, further comprising:
sending the processed identity to a web server associated with the service terminal; and
receiving a service approval signal, generated based on the processed identity, from the web server, the service approval signal having been generated by the web server which confirms an identity corresponding to the identity request signal based on the processed identity.
